(19) United States
(12) Patent Application Publication
(10) Pub. No.: US 2010/0229676 A1
(43) Pub. Date: Sep. 16, 2010

(54) QUICK RELEASE DEVICE

(76) Inventor: Chung-I Chen, Taichung Hsien (TW)

Correspondence Address: Chien-Hui Su, P. O. Box 70-121 Taichung, Taichung City, 40899, TW

(21) Appl. No.: 12/404,330

(22) Filed: Mar. 15, 2009

(51) Int. Cl. B62M 3/08

(52) U.S. Cl. 74/594.4

(57) ABSTRACT

A quick release device includes a crank and a quick release assembly. The crank has a pedal hole and a quick release hole. The quick release hole is communicated with the pedal hole. The quick release assembly is partially received in the quick release hole. The quick release assembly includes a rod received in the quick release hole, a spring sleeved on the rod, a stopper mounted in the quick release hole, and a pull button connected to the rod. The rod has an enlarged head formed in one end thereof. One end of the spring is abutted against the enlarged head and the other end of the spring is abutted against the stopper such that the enlarged head protrudes into the pedal hole. When pulling the pull button, the enlarged head retracts into the quick release hole.

### BACKGROUND OF THE INVENTION

1. Field of the Invention

The present invention relates to a quick release device, and more particularly to a quick release device for a bicycle crank and a bicycle pedal.

2. Description of Related Art

A conventional quick release device in accordance with the prior art comprises a pedal, a fixing threaded sleeve and a crank arm. The pedal has one end formed with a rotation shaft which has a free end formed with a screw portion having an outer thread. The fixing threaded sleeve has a center formed with a screw bore screwed on the screw portion of the rotation shaft of the pedal. The fixing threaded sleeve has an outer wall protruded with two radially opposite locking flanges. The crank arm has a free end formed with a mounting hole for insertion of the fixing threaded sleeve. The mounting hole of the crank arm has a wall formed with two insertion guide grooves for insertion of the two locking flanges of the fixing threaded sleeve. Each of the two insertion guide grooves has one side formed with a locking recess for locking the respective locking flange of the fixing threaded sleeve by rotation of the fixing threaded sleeve. The locking recess of each of the two insertion guide grooves is distributed on a diameter of the mounting hole.

The conventional quick release device has to machine the outer thread of the rotation shaft and the fixing threaded sleeve. The manufacturing processes are complicated and precise; therefore the manufacturing costs are high. After a period of assembling/disassembling, the conventional quick release will loose. The pedal is separated from the crank such that the rider falls over. The enlarged mounting hole in the crank also reduces the strength of the crank.

The present invention has arisen to mitigate and/or obviate the disadvantages of the conventional quick release device.

### SUMMARY OF THE INVENTION

The main objective of the present invention is to provide an improved quick release device which permits user to assemble/disassemble the crank and pedal easily.

To achieve the objective, the quick release device includes a crank and a quick release assembly. The crank has a pedal hole defined therein and a quick release hole defined in a lateral thereof. The quick release hole is communicated with the pedal hole. The quick release assembly is partially received in the quick release hole. The quick release assembly includes a rod received in the quick release hole, a spring sleeved on the rod, a stopper mounted in the quick release hole, and a pull button connected to the rod. The rod has an enlarged head formed in one end thereof. The rod passes through the stopper. One end of the spring is abutted against the enlarged head and the other end of the spring is abutted against the stopper such that the enlarged head protrudes into the pedal hole. When pulling the pull button, the enlarged head retracts into the quick release hole.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a quick release device in accordance with the present invention;

FIG. 2 is an assembled perspective view of the quick release device in accordance with the present invention;

FIG. 3 is a partial cross-sectional side plane view of the quick release device in accordance with the present invention;

FIG. 4 shows the disassembling operation of the quick release device in accordance with the present invention;

FIG. 5 shows the assembling operation of the quick release device in accordance with the present invention; and

FIG. 6 is a partial cross-sectional top plan view of a second embodiment of a quick release device in accordance with the present invention.

### DETAILED DESCRIPTION OF THE INVENTION

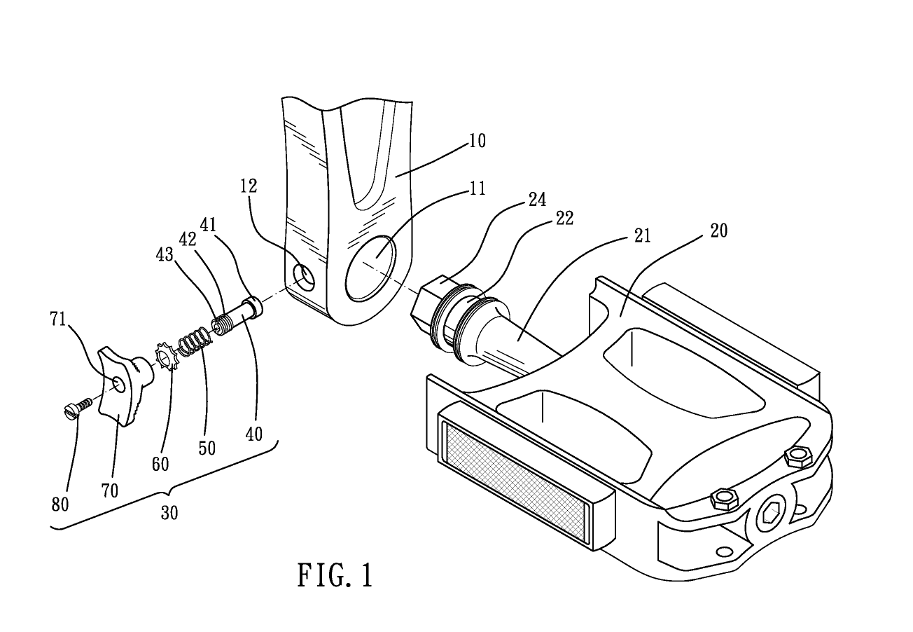

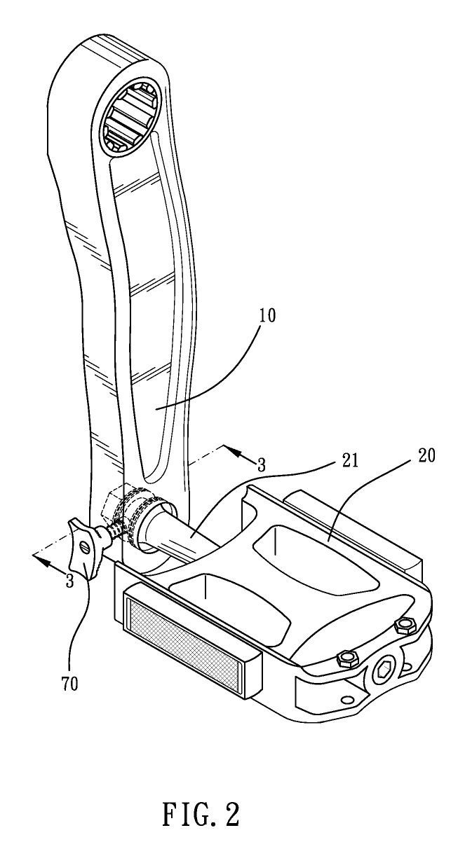

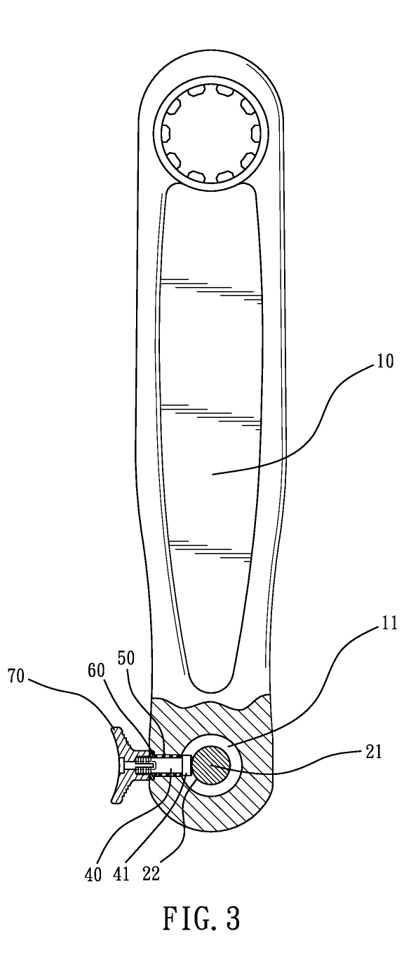

Referring to the drawings and initially to FIGS. 1-4, a quick release device in accordance with the present invention comprises a crank 10 and a pedal 20 connected to the crank 10.

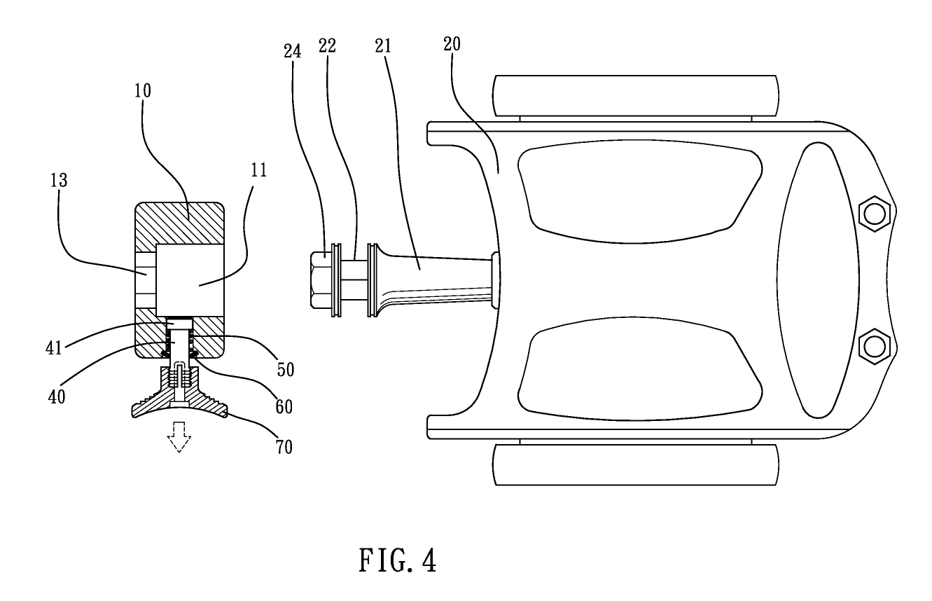

The crank 10 has a pedal hole 11 defined in one end thereof. The cranks 10 has a quick release hole 12 defined in a lateral thereof. The quick release hole 12 is communicated with the pedal hole 11 and perpendicular to the pedal hole 11. The crank 10 has an engaging hole 13 (see FIG. 4) defined therein and communicated with the pedal hole 11. The engaging hole 13 is in a shape of hexagon.

The pedal 20 includes a pedal spindle 21. The pedal spindle 21 is inserted into the pedal hole 11. The pedal spindle 21 has an annular groove 22 defined therein and corresponding to the quick release hole 12. The pedal spindle 21 has an engaging protrusion 24 formed in one end thereof and corresponding to the engaging hole 13. The engaging protrusion 24 is in a shape of hexagon. In other embodiment, the engaging protrusion 24 is in a shape of polygon. When the engaging protrusion 24 engages with the engaging hole 13, the pedaling force transmits from pedal 20 to the crank 10.

The quick release device in accordance with the present invention further comprises a quick release assembly 30 partially received in the quick release hole 12. The quick release assembly 30 includes a rod 40, a spring 50, a stopper 60, a pull button 70, and a screw 80. The rod 40 is received in the quick release hole 12. The rod 40 has a head 41 formed in one end thereof and a threaded portion 42 formed on the other end thereof. A diameter of the head 41 is greater than that of the rod 40. The head 41 is selectively protruded into the pedal hole 11. The threaded portion 42 has a split 43 defined therein. The stopper 60 is a star-shaped washer. The stopper 60 is fixedly mounted in the quick release hole 12. The pull button 70 has a through hole 71 defined therein.

When assembling, the head 41 of the rod 40 is inserted into the quick release hole 12. The spring 50 and the stopper 60 are sequentially sleeved on the rod 40. The stopper 60 is pressed in the quick release hole 12 such that one end of the spring 50 is abutted against the head 41 and the other end of the spring 50 is abutted against the stopper 60. The threaded portion 42 of rod 40 passes through the stopper 60 and threadedly connects to the pull button 70. The screw 80 passes through the through hole 71 and threadedly connects to the rod 40. The split 43 is provided to enlarge the threaded portion 42 such that the rod 40 and the pull button 70 are firmly connected to each other. The head 41 is subjected the force provided by the spring 50 to protrude into the pedal hole 11.

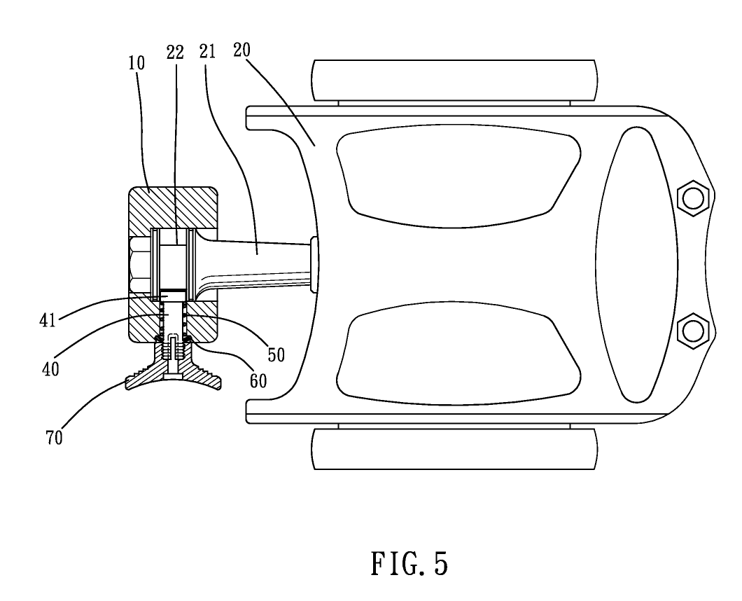

Referring to FIGS. 4 and 5, the assembling/disassembling operation of the quick release device in accordance with the present invention is illustrated. When pulling the pull button 70, the head 41 retracts into the quick release hole 12. The pedal 20 is pulled out from the pedal hole 11 as shown in FIG. 4 to disassemble the crank 10 and the pedal 20. When pulling the pull button 70 and inserting the pedal 20 into the pedal hole 11, the engaging protrusion 24 engages with the engaging hole 13. After releasing the pull button 70, the head 41 annular groove 22 protrudes into the pedal hole 11 such that the head 41 engages with the annular groove 22. The head 41 is subjected the force provided by the spring 50 to firmly connect the crank 10 and the pedal 20.

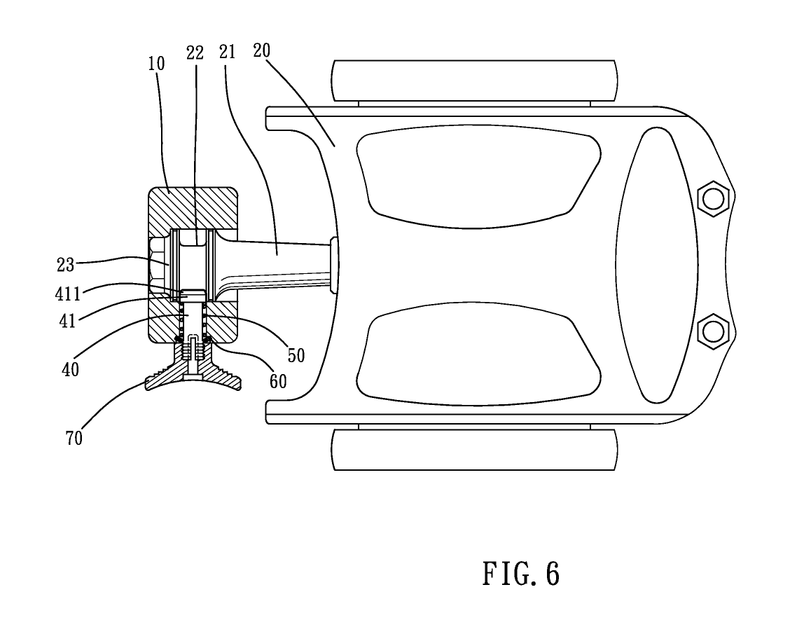

Referring to FIG. 6, a second embodiment of a quick release device in accordance with the present invention is illustrated. The elements and the efforts which are the same with the first embodiment are not described, only the differences are described. The pedal 20 has a first guiding face 23 formed therein. The first guiding face 23 is disposed between the annular groove 22 and engaging protrusion 24. The head 41 has a second guiding face 411 formed in a free end thereof. When the pedal 20 is inserted into the pedal hole 11, the first guiding face 23 abuts against the second guiding face 24 such that the head 41 is pushed to retract. When the annular groove 22 is corresponding to the head 41, the head 41 engages with the annular groove 22. Therefore, user does not need to pull the pull button 70.

Although the invention has been explained in relation to its preferred embodiment, it is to be understood that many other possible modifications and variations can be made without departing from the spirit and scope of the invention as hereinafter claimed.

What is claimed is:

1. A quick release device comprising:
a crank having a pedal hole defined therein, the crank having a quick release hole defined in a lateral thereof, the quick release hole communicated with the pedal hole; and
a quick release assembly partially received in the quick release hole, the quick release assembly comprising:
a rod received in the quick release hole, the rod having an enlarged head formed in one end thereof;
a spring sleeved on the rod;
a stopper mounted in the quick release hole, wherein one end of the spring is abutted against the enlarged head and the other end of the spring is abutted against the stopper such that the enlarged head protrudes into the pedal hole; wherein the rod passes through the stopper; and
a pull button connected to the rod, wherein when pulling the pull button, the enlarged head retracts into the quick release hole.

2. The quick release device as claimed in claim 1, wherein the crank has an engaging hole defined therein and communicated with the pedal hole.

3. The quick release device as claimed in claim 2 further comprising a pedal partially received in the pedal hole, the pedal having a pedal spindle, the pedal spindle having an engaging protrusion formed in one end thereof and an annular groove defined therein, the engaging protrusion corresponding to the engaging hole, the annular groove corresponding to the quick release hole.

4. The quick release device as claimed in claim 3, wherein the pedal spindle has a first guiding face formed therein.

5. The quick release device as claimed in claim 4, wherein the enlarged head has a second guiding face formed in a free end thereof.

6. The quick release device as claimed in claim 1, wherein the stopper is a star-shaped washer.

7. The quick release device as claimed in claim 1, wherein the rod has a threaded portion formed in one end thereof for connecting the pull button.

8. The quick release device as claimed in claim 1, wherein the quick release hole is perpendicular to the pedal hole.
